(19) United States
(12) Patent Application Publication
(10) Pub. No.: US 2020/0125924 A1
(43) Pub. Date: Apr. 23, 2020

(54) METHOD AND SYSTEM FOR ANALYZING A NEURAL NETWORK

(71) Applicant: Siemens Aktiengesellschaft, MUNCHEN (DE)

(72) Inventor: Pankaj Gupta, MUNCHEN (DE)

(21) Appl. No.: 16/166,321

(22) Filed: Oct. 22, 2018

(51) Int. Cl. G06N 3/04; G06N 3/08

(52) U.S. Cl. CPC G06N 3/0445; G06N 3/08

(57) ABSTRACT

The disclosed relates to an analyzing of a neural network, in particular an already trained neural network, for example a recurrent neural network. For this purpose, input data to the neural network are stepwise increased. After each step, the probability for a specific classification of the neural network is analyzed. Upon the probability for the specific classification raises a predetermined threshold value, the data element which has been added last to the input data is identified to be relevant for the respective decision.

### FIELD OF TECHNOLOGY

The present invention relates to a method for analyzing a neural network. The present invention further relates to a system for analyzing a neural network. In particular, the present invention relates to an analysis of an already trained neural network.

### BACKGROUND

Neural networks, in particular artificial neural networks currently are employed in many technical applications. Neural networks may be considered as a framework for many different machine learning algorithms to work together and process complex data inputs. Such systems “learn” to perform tasks by considering examples, generally without being programmed with any task-specific rules. For example, in image recognition, the neural network might learn to identify images that contain specific content by analyzing example images and using the results to identify the specific content in other images. The neural networks do this without any prior knowledge about the specific content. Moreover, the neural network automatically generates identifying characteristics from the learning materials which have been processed.

Since the neutral network acts as a “black box” by receiving input data and providing output data, it is rather difficult to understand the operation of such a neural network. Furthermore, there may be some difficulties in verifying the operation and the quality of the neural network after the neural network has been trained.

Hence, there is a need for a method and a system for verifying a trained neural network. Furthermore, there is a need for a method and a system which can assist a user understanding a trained neural network, in particular understanding a relationship between input data and the corresponding output of a neural network.

### SUMMARY

The present invention provides a method and a system for analyzing a neural network with the features of the independent claims. Further advantageous embodiments are subject matter of the dependent claims.

According to a first aspect, a method for analyzing a neural network is provided. The method comprises a step of successively providing a stepwise increasing set of input data to the neural network. The method further comprises a step of receiving an output of the neural network in response to the provided input data. In particular, the output of the neural network comprises a prediction probability for a specific classification. Further, the method comprises comparing the prediction probability for the specific classification with a predetermined threshold value, and identifying a characteristic element in the provided input data, if the prediction probability for the specific classification exceeds the predetermined threshold value.

According to a further aspect, a system for analyzing a neural network is provided. The system comprises a data generator and an analyzing unit. The data generator is configured to successively provide a stepwise increasing set of input data to the neural network. The analyzing unit is configured to receive an output of the neural network in response to the provided input data. The output may comprise a prediction probability for a specific classification. The analyzing unit is further configured to compare the prediction probability for the specific classification with a predetermined threshold value, and to identify a characteristic element in the provided input data, if the prediction probability for the specific classification exceeds the predetermined threshold value.

According to still a further aspect, a non-transient computer readable medium is provided. The non-transient computer readable medium may contain program instructions for causing a computer to perform the method according to the first aspect of the present invention.

The present invention is based on the fact that it is rather difficult to analyze and understand an already trained neural network. Usually, a neural network is considered as a “black box” receiving input data and providing an output based on the received input data. However, it is usually not possible to go inside an already trained neural network and to perform an analysis of the trained neural network in order to understand the operation of the neural network or to verify the reliability of the trained neural network.

It is therefore an idea of the present invention to provide a method and system for analyzing a neural network, in particular an already trained neural network. Especially, the present invention aims to identify specific patterns in the input data which is responsible for a particular decision of the neural network. Based on this information, it is possible to understand the operation of a neural network in more detail. Furthermore, it may be possible to verify a proper operation of the neural network. In particular, it may be possible to verify the reliability of the trained neural network for making appropriate decisions.

The neural network may be any kind of neural network. In particular, the method and the system may be subjected to an already trained neural network. The neural network may be trained for making a number of one or more specific decisions. Accordingly, by providing input data to such a trained neural network, the neural network may provide a decision whether or not a specific condition is fulfilled. The decision for the specific condition may comprise a probability value for the one or more specific conditions which are verified by the neural network. For example, the neural network may be implemented by a computer system comprising one or more processing units. In particular, the computer system may comprise a number of one or more central processing units (CPU), graphic processing units (GPU) or any other kind of processing units. In particular, the neural network may be also realized by a number of one or more processing units which are specifically configured for neural network applications.

The neural network may be trained with appropriate training data in advance. For this purpose, any appropriate training scheme may be applied. For example, a set of multiple training data is provided to the neural network, wherein the training data comprise labels for indicating one or more specific properties of each training data element. However, it is understood that any other appropriate training scheme may be also applied.

After the neural network has been trained, it may be possible to provide input data to the trained neural network and to obtain an output of the trained neural network in response to the provided input data. The output of the neural network may comprise a decision for a number of one or more specific conditions. In particular, the decision may comprise a probability value for each of the number of specific conditions. For example, the neural network may provide a decision comprising a probability value for describing a probability that a specific element is included in the provided input data.

In order to understand the operation of the neural network or to verify the operation of the trained neural network, the present invention aims to identify specific elements in the input data which are responsible for a decision of the trained neural network. It is for this purpose, that data sets are provided step by step to the trained neural network, wherein in each step the provided data set is increased by a further data element. In particular, in each step an additional element is added to the data set which has been provided in the step before. Accordingly, it is possible to identify a variation in the decision provided by the neural network in response to the amended (expanded) data set. Accordingly, the variation in the decision, e.g. the variation in the probability for a specific decision, may be associated with the currently added element in the input data.

The method for analyzing a neural network according to the first aspect of the present invention may be realized, for example, by a computer system comprising a number of one or more processors. The computer system may further comprise a memory for storing instructions to perform the method according to the first aspect. Furthermore, an additional memory may store data for generating the input data which are to be provided to the neural network. The computer system for performing the method according to the first aspect and the neural network may be communicatively coupled with each other. For example, data interfaces may be used for providing the input data to the neural network and for receiving the output of the neural network.

As already mentioned above, the successively providing a stepwise increasing set of input data to the neural network may start with a small set of input data. For example, the step of providing the input data to the neural network may start with a single data element. In each step of providing input data to the neural network, at least one further data element may be added to the previously provided set of input data. Accordingly, the set of input data increases with each step of providing the input data to the neural network. In particular, each step of providing input data to the neural network comprises all previously provided input data and an additional data element.

In response to the provided input data, the neural network provides for each provided set of data a corresponding output. The output of the neural network may relate to a decision in response to the provided input data. In particular, the provided output data may comprise a probability value for a specific decision or classification. Accordingly, the variation of this probability value can be monitored in relation with the stepwise providing of input data.

By identifying the data element which causes that the probability value for a specific decision exceeding a predetermined threshold value, the respective data element may be considered to be a reason for the respective decision of the neural network. Hence, the data element which has been added to the provided input data set in the last step of providing input data to the neural network can be identified to be responsible for the respective decision. Moreover, a number of two or more data elements which have been added to the provided input data set in the last steps of providing input data to the neural network may be grouped together and this group may be considered to be responsible for the respective decision of the neural network.

In a possible embodiment, the neural network may comprise a recurrent neural network. Recurrent neural networks are a class of artificial neural networks where connections between the nodes form a direct graph along a sequence. This allows it to exhibit temporal dynamic behavior for a time sequence. Unlike feed forward neural networks, recurrent neural networks may use internal states to process sequences of input. The storage of state of a recurrent neural network may be under direct control of the neural network. Hence, understanding the behavior of such recurrent neural networks is rather difficult. Therefore, there is a particular need for understanding and verifying such recurrent neural networks.

In a possible embodiment, the input data provided to the neural network may comprise training data which have been used for training the neural network. By using same or at least similar data for training and for analyzing the neural network, it can be verified how the individual elements of the training data may have influenced the decision-making of the neural network.

In a possible embodiment, the set of input data may comprise a number of position indicators for indicating a target entity of the input data. The position indicators may be any appropriate indication for specifying a target entity in the input data. For example, the position indicators may be additional elements in the input data, for example for highlighting a target entity of the input data. However, any other appropriate position indicator for specifying a target entity in the input data may be also possible. In this way, a specific target entity of the input data can be highlighted for indicating a target entity to the neural network. Hence, the response of the neural network based on the analyzing of the neural network according to the present invention can be subjected to these target entities.

In a possible embodiment, the stepwise providing of input data may comprise adding a further element of input data to previously provided input data. Accordingly, in each step of providing input data to the neural network, at least one additional data element is added to the data set provided in the previous step of provided input data. Accordingly, the set of input data is increased by at least one additional input element, wherein the previously provided input data are maintained, i.e. no previously provided input data are removed when providing the next set of input data to the neural network.

In a possible embodiment, the step of identifying the characteristic element in the provided input data may comprise identifying a number of added input elements of input data which have been added in previous steps of providing input data. The number of identified added elements may be one, i.e. only a single element is identified. Alternatively, it may be also possible to identify a number of more than one element, for example, 2, 3, 4, 5 or even more data elements which have been added in the corresponding number of previous steps of providing input data to the neural network. For example, it may be possible to consider all data elements which have been added in the last three steps of providing input data. Accordingly, all these elements which have been added in the last three steps may be considered to be relevant for the decision-making of the neural network. However, it is understood that any other number of previously added data elements may be also grouped together for identifying the relevant data elements.

In a possible embodiment, the neural network may comprise a neural network which is configured to perform a semantic analysis. A semantic analysis may apply an analysis of text data. For example, it may be possible to analyze a sentence word by word in order to identify specific statements in the respective text. A semantic analysis may be used for any appropriate application. For example, a bug report of a device may be analyzed in order to identify specific information, for example a characterization of the bug or even a reason for a bug. However, any other appropriate application for analyzing a text may be also possible. For example, the analysis of a text may be used for an automated translation of a text or any other application. Furthermore, it is understood that the analysis of the neural network may be applied to any kind of other data. For example, image data may be analyzed, sensor data may be processed by the neural network, etc.

In a possible embodiment, the set of input data which is provided to the neural network may comprise semantic data. In particular, the input date provided to the neural network may comprise words or phrases. However, it is understood that any other kind of input data may be also provided to a neural network. For example, it may be also possible to provide measurements, sensor data, audio data, video data, images or the like to a neural network for analyzing the operation of the neural network.

In a possible embodiment, the characteristic element in the input data may comprise a representative pattern, in particular a representative pattern responsible for a decision-making of the neural network. As already mentioned above, the representative pattern may comprise a number of one or more data elements which have been added to the provided input data for the neural network in the number of one or more steps for providing input data to the neural network.

In a possible embodiment of the second aspect, the neural network may comprise a recurrent neural network.

In a further possible embodiment of the second aspect, the input data may comprise training data which have been used for training the neural network.

In a possible embodiment of the second aspect, the set of input data may comprise a number of position indicators for indicating a target entity in the input data.

In a further possible embodiment of the second aspect, the data generator is configured to add a further element of input data to previously provided input data.

In a further possible embodiment, the analyzing unit is configured to identify the characteristic element in the provided input data by identifying a number of added data elements of input data which have been added in previous steps of providing input data.

In a further possible embodiment of the second aspect, the neural network comprises a neural network configured to perform a semantic analysis.

In a further possible embodiment, the data generator is configured to provide input data comprising semantic data, in particular words or phrases.

In a further possible embodiment, the characteristic element in the input data comprises a representative pattern responsible for a decision-making of the neural network.

With the present invention it is therefore now possible to analyze a decision-making of a trained neural network. In particular, it is possible to identify highly relevant elements in the input data which are responsible for a particular decision of the neural network. For this purpose, the input data provided to the neural network are stepwise increased by adding a further data element to a data set provided in a previous step. Accordingly, by identifying a significant increase in the prediction probability for a specific classification, the responsible data element for this increase of the prediction probability can be identified.

### BRIEF DESCRIPTION

For a more complete understanding of the present invention and advantages thereof, reference is now made to the following description taken in conjunction with the accompanying drawings.

The invention is explained in some more detail below using exemplary embodiments which are specified in the schematic figures of the drawings in which:

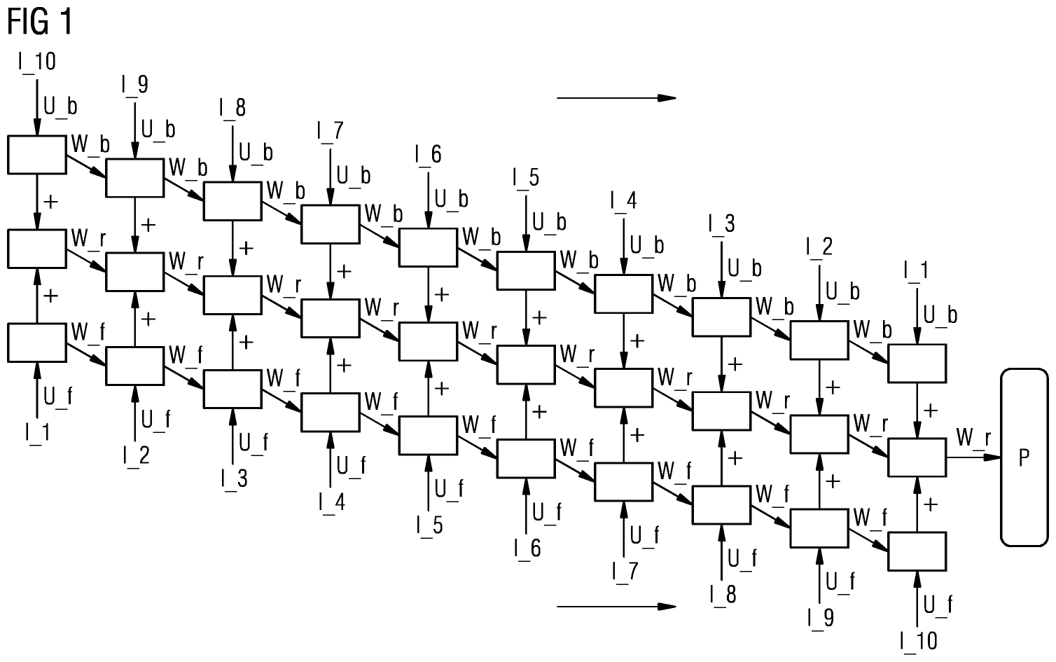

FIG. 1 shows a block diagram of a recurrent neural network which may be analyzed in a possible embodiment of the present invention;

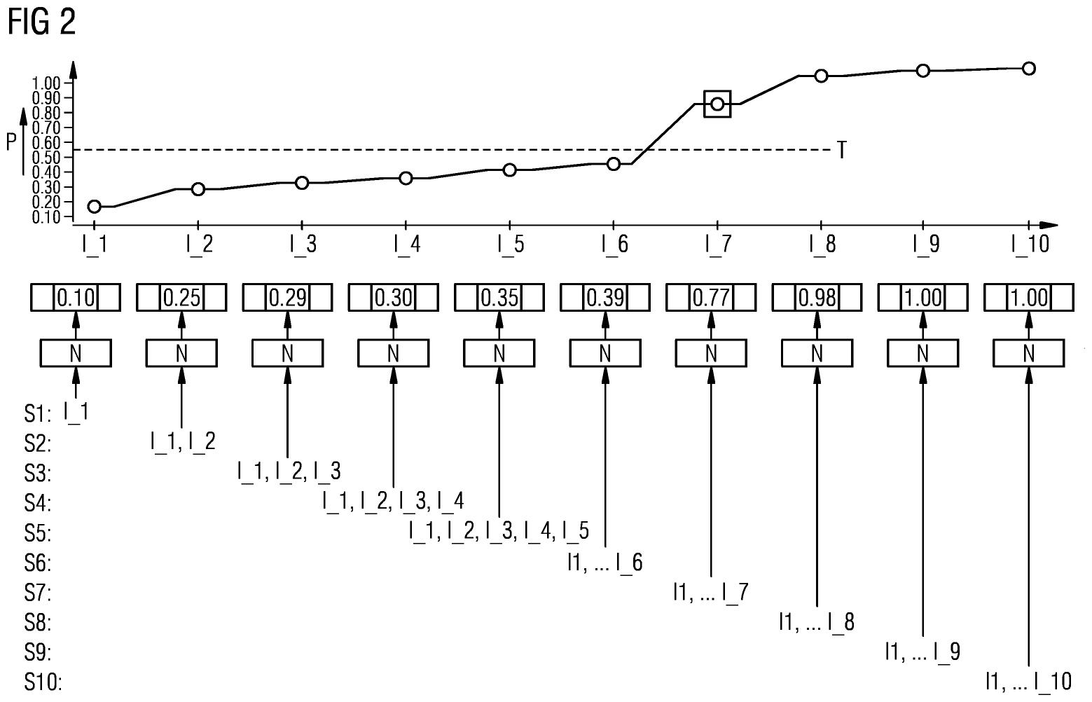

FIG. 2 shows a diagram illustrating the prediction probability during an analysis of a neural network according to an embodiment of the present invention;

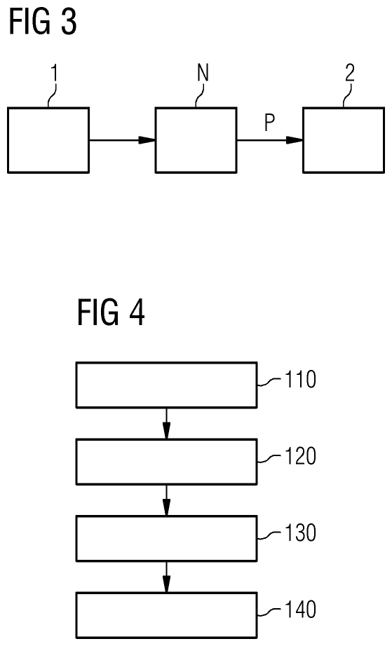

FIG. 3 shows a system for analyzing a neural network according to an embodiment of the present invention; and

FIG. 4 shows a flowchart illustrating a method for analyzing a neural network according to an embodiment.

The appended drawings are intended for providing further understanding of the embodiments of the invention. The drawings illustrate embodiments and, in conjunction with the description, help to explain principles and concepts of the invention. Further embodiments and many of the advantages mentioned become apparent in view of the drawings. The elements in the drawings are not necessarily shown in scale.

### DETAILED DESCRIPTION

FIG. 1 shows a schematic block diagram illustrating a decision-making of a bi-directional recurrent neuronal network. The recurrent neuronal network comprises a forward path 10 which processes the original input, a backward path 30 which processes the reversed input and a combination of both 30. The forward and the backward paths are combined by adding the hidden layers. There is also a connection to previous combined hidden layers with weight W_r with a motivation to include all intermediate hidden layers into the final decision of the network. W_f is the weight matrix connecting hidden units in forward networks, W_b is the weight matrix connecting hidden units in backward networks, and W_r is the weight matrix connecting the hidden vectors of combined forward and backward networks. U_f and U_b are the weight matrixes between hidden units and input I_i in forward and backward networks, respectively.

The recurrent neural network outputs a decision for a specific condition. In particular, this decision may comprise a probability value for a specific condition.

For example, input data to the recurrent neural network may comprise a set of data elements I_1 to I_10. In a possible embodiment, the input data may comprise a sentence comprising multiple words. In the illustrated example, input data I_1 to I_10 comprise a sentence of ten elements, e.g. words. However, it may be also possible that a sentence comprising another number of words may be provided to the neural network. Furthermore, any other kind of input data may be provided to a neural network. For example, the input data may relate to image data, video data, sensor data, in particular measurement data or any other kind of input data. Thus, even though the present invention is described in the following with respect to a semantic analysis of text data, the present invention is not limited to such semantic data. Furthermore, any other kind of data may be processed by an appropriately trained neural network.

FIG. 2 shows a schematic illustration of a decision-making of a trained neural network when providing input data to the trained neural network. As can be seen in FIG. 2, there is a sequence of ten steps S1 to S10 for providing input data to the neural network. In each step S1 to S10, the input data are increased by a further data element. In step S1, only a single data element I_1 is provided to the neural network. In the next step S2, an additional data element I_2 is added to the previously provided data element I_1. Accordingly, in the third step, a third data element I_3 is added to the previously provided data elements I_1 and I_2. Accordingly, in each step a further data element is added to the previously provided set of data elements. Again, even though a specific case for ten data elements I_1 to I_10 is illustrated in FIG. 2, the present invention is not limited to only ten data elements. Moreover, any other number of data elements I_i may be also possible.

As can be further seen in FIG. 2, a specific probability for a predetermined decision is determined by the neural network. For example, by providing only a single data element I_1 to the neural network, the probability P for the specific decision is 0.10. After providing a set of two data elements I_1 and I_2 to the neural network, the probability for the specific decision increases to 0.25. Furthermore, the probability P for the specific decision increases by adding further data elements to the provided data set. In particular, when providing seven data elements I_1 to I_7 to the neural network, the probability P for the specific decision increases from 0.39 to 0.77. In particular, the probability P rises above a preset threshold value T. In the present case according to FIG. 2, the threshold value T is set to 0.50.

After detecting that the probability P raises above the preset threshold value T, it is determined that the previously added data element I_7 has significant impact to the decision-making of the neural network. Accordingly, the respective data element I_7 is identified to be a relevant data element. In case of a semantic analysis, the word related to the respective data element I_7 may be considered as a word which has high impact to the decision-making of the neural network.

However, it may be also possible to consider a number of two or more data elements I_i which have been added previously to the provided data set as relevant. For example, an n-gram may be considered to be relevant for the decision-making of the neural network. For example, the previously added three data elements may be considered as a 3-gram which is relevant for the decision-making of the neural network.

The predetermined threshold T may be a fixed threshold value, for example 0.50. However, it is understood that any other appropriate threshold value higher or lower than 0.50 may be also possible. Furthermore, it may be possible to adapt the threshold value T, in particular to dynamically adapt the threshold value T depending on the respective application.

Furthermore, it may be also possible to add appropriate indicators for highlighting a target entity in the provided input data. For example, a specific word may be highlighted by a data element before and/or behind the target word. However, any other appropriate method for highlighting a target entity in the provided input data may be also possible.

FIG. 3 shows a schematic block diagram of a system for analyzing a neural network according to an embodiment. The system comprises a data generator 1 and an analyzing unit 2. The data generator 1 may successively provide input data to the neural network N. In particular, the data generator may successively provide a stepwise increasing set of input data to the neural network as described above.

The analyzing unit 2 may receive an output of the neural network N in response to the provided input data. In particular, the output of the neural network which is received by the analyzing unit 2 may comprise a prediction probability for a specific classification. The analyzing unit 2 may further compare the prediction probability for the specific classification with the predetermined threshold value T. If the prediction probability for the specific classification exceeds a predetermined threshold value T, the analyzing unit 2 may identify a characteristic element in the provided input data.

Furthermore, the data generator 1 and the analyzing unit 2 may perform any appropriate operation as described above in connection with FIG. 1 and FIG. 2.

FIG. 4 shows a schematic illustration of a flow diagram illustrating a method for analyzing a neural network according to an embodiment.

The method comprises a step 110 for successively providing a stepwise increasing set of input data to the neural network. In particular, the input data may be provided by a data generator.

In step 120, an output of the neural network may be received in response to the provided input data. The output may be received by an analyzing unit 2. The output may comprise a prediction probability for a specific classification.

In step 130, the prediction probability for a specific classification is compared with a predetermined threshold value T. This comparison may be also performed by the analyzing unit 2.

In step 140, a characteristic element in the provided input data is identified, if the prediction probability for the specific classification exceeds a predetermined threshold value T. Again, this identification may be performed by the analyzing unit 2.

Based on the identified characterizing element of a dataset which is highly relevant for a specific decision of the neural network, the neural network can be analyzed. For example, it may be possible to verify the training of the neural network. If the identified characterizing elements correspond to appropriate elements in the provided input data, the training of the neural network may be considered to be appropriate. Otherwise, if at least the some relevant elements in the provided input data are not identified to be characterizing elements, the neural network may be considered to not trained sufficiently. Furthermore, if some identify characterizing elements are considered to be not relevant for a decision of the trained neural network, this may also be an indication for a not sufficiently trained neural network. Hence, additional trading of the neural network may be considered to be necessary. Additionally or alternatively, the dataset used for trading the neural network have to be adapted. In particular, the result of the identified characterizing elements may be taken into account when preparing further or alternative training data for a neural network. In this way, the trading of a neural network can be improved. In particular, an automated configuration of appropriate training data may be applied based on the identified characterizing elements.

For example, if some highly relevant elements are not identified to be characterizing elements, further additional training data associated with such elements may be selected for training the neural network. If some characterizing elements are identified which are not considered to be relevant, the training is that may be verified with respect to such elements. However, it is understood, that any other appropriate modification of the training data may be also applied based on the identified characterizing elements.

The neural network may be, for example, a neural network for performing a semantic analysis of text data. For example, the neural network may be a network for identifying particular semantic relations in a sentence. In such a case, the identification of characterizing elements may identify a word or a group of words which are responsible for making a decision for a particular relation in the process the sentence. However, it is understood, that the neural network may be a neural network used for any other processing of semantic data. Furthermore, the present invention may be also applied to neural networks dealing with any other kind of data, for instance sensor data, measurements, images, video data, audio data, speech, et cetera. Accordingly, the characterizing elements which are identified may be characterizing elements related to the respective data. For example, a particular feature in an image may be considered to be in characterizing element and a processing image data. Alternatively, a particular audio sequence may be a characterizing element when analyzing audio data or speech data.

The analysis of the neural network according to the present invention may be used, for example, in order to analyze and improve neural networks related to an industrial application. For example, the neural network may be a neural network analyzing data of a technical system such as a production system, a system related to a power plant, e.g. a gas turbine, a control system, et cetera. For example, measurements, sensor data or the like may be processed by the respective neural network. Furthermore, the neural network may be neural networks related to an analysis of the functionality of the respective system. For example, error messages may be analyzed by the neural network in order to identify a malfunction and/or to provide a recommendation in order to recover an error of the system. However, it is understood, that any other application to the neural network may be also possible. Thus, the analysis and improvement of the neural network based at the identified characterizing elements may be adapted accordingly.

Summarizing, the present invention relates to an analyzing of a neural network, in particular an already trained neural network, for example a recurrent neural network. For this purpose, input data to the neural network are stepwise increased. After each step, the probability for a specific classification of the neural network is analyzed. Upon the probability for the specific classification raises a predetermined threshold value, the data element which has been added last to the input data is identified to be relevant for the respective decision.

1. A method for analyzing a neural network, the method comprising the steps of:
successively providing a stepwise increasing set of input data to the neural network;
receiving an output of the neural network in response to the provided input data, said output comprising a prediction probability for a specific classification;
comparing the prediction probability for the specific classification with a predetermined threshold value; and
identifying a characteristic element in the provided input data, if the prediction probability for the specific classification exceeds the predetermined threshold value.

2. The method of claim 1, wherein the neural network comprises a recurrent neural network.

3. The method of claim 1, wherein the input data comprise training data which have been used for training the neural network.

4. The method of claim 1, wherein the set of input data comprises a number of position indicators for indicating a target entity in the input data.

5. The method of claim 1, wherein the stepwise providing of input data comprises adding a further element of input data to previously provided input data.

6. The method of claim 5, wherein the identifying the characteristic element in the provided input data comprises identifying a number of added elements of input data which have been added in previous steps of providing input data.

7. The method of claim 1, wherein the neural network comprises a neural network configured to perform a semantic analysis.

8. The method of claim 1, wherein the set of input data comprise semantic data, in particular words or phrases.

9. The method of claim 1, wherein the characteristic element in the input data comprises a representative pattern responsible for a decision making of the neural network.

10. A non-transient computer readable medium containing program instructions for causing a computer to perform a method of:
successively providing a stepwise increasing set of input data to the neural network;
receiving an output of the neural network in response to the provided input data, said output comprising a prediction probability for a specific classification;
comparing the prediction probability for the specific classification with a predetermined threshold value; and
identifying a characteristic element in the provided input data if the prediction probability for the specific classification exceeds the predetermined threshold value.

11. A system for analyzing a neural network, the system comprising:
a data generator for successively providing a stepwise increasing set of input data to the neural network; and
an analyzing unit for receiving an output of the neural network in response to the provided input data, said output comprising a prediction probability for a specific classification, comparing the prediction probability for the specific classification with a predetermined threshold value, and identifying a characteristic element in the provided input data, if the prediction probability for the specific classification exceeds the predetermined threshold value.

12. The system of claim 11, wherein the neural network comprises a recurrent neural network.

13. The system of claim 11, wherein the input data comprise training data which have been used for training the neural network.

14. The system of claim 11, wherein the set of input data comprises a number of position indicators for indicating a target entity in the input data.

15. The system of claim 11, wherein said data generator is configured to add a further element of input data to previously provided input data.

16. The system of claim 15, wherein said analyzing unit is configured to identify the characteristic element in the provided input data by identifying a number of added elements of input data which have been added in previous steps of providing input data.

17. The system of claim 11, wherein the neural network comprises a neural network configured to perform a semantic analysis.

18. The system of claim 11, wherein said data generator is configured to provide input data comprising semantic data, in particular words or phrases.

19. The system of claim 11, wherein the characteristic element in the input data comprises a representative pattern responsible for a decision making of the neural network.
